(19) United States
(12) Patent Application Publication
(10) Pub. No.: US 2014/0063403 A1
(43) Pub. Date: Mar. 6, 2014

(54) DISPLAY MODULE AND DISPLAY DEVICE

(71) Applicant: SHENZHEN CHINA STAR OPTOELECTRONICS TECHNOLOGY CO., LTD., Shenzhen, (CN)

(72) Inventors: Shihhsiang Chen, Shenzhen (CN); Gang Yu, Shenzhen (CN)

(73) Assignee: SHENZHEN CHINA STAR OPTOELECTRONICS TECHNOLOGY CO., LTD., Shenzhen (CN)

(21) Appl. No.: 13/643,084

(22) PCT Filed: Sep. 27, 2012
(86) PCT No.: PCT/CN2012/082112

§ 371 Date: Oct. 24, 2012

(30) Foreign Application Priority Data
Aug. 31, 2012 (CN) 201210319102.0

(51) Int. Cl. G02F 1/1333; G02F 1/1335

(52) U.S. Cl. CPC G02F 1/133308; G02F 1/133603
USPC 349/58; 362/97.1

(57) ABSTRACT

A display module includes a display panel, and a frame supporting the display panel. The frame is configured with a support structure directly supporting a back surface of the display panel, and the back surface is arranged opposite to a display surface of the display panel. The support structure of the frame is configured with suction cup(s) that holds the back surface of the display panel.

### TECHNICAL FIELD

The present disclosure relates to the field of flat panel display devices, and more particularly to a display module and a display device.

### BACKGROUND

Flat panel displays have become mainstream displays at present, and include multiple types such as liquid crystal display (LCD) devices, plasma display devices, organic light emitting display (OLED) devices, and the like. The flat panel displays have main characteristics of being light weight, thin, and energy efficient. Though the flat panel displays are thinner compared with cathode ray tube (CRT) displays, and has a narrower frame compared with the CRT display, the flat panel displays may not meet increased consumption taste of consumers yet.

Take an LCD device as an example. As a key component of the LCD device, an LCD module is mainly used to provide sufficient brightness and uniformly distributed light sources, to display images. As shown in FIG. 1, an LCD module of an LCD device includes a backplane 300, a reflector sheet 400 arranged in the backplane 300, a light guide panel (LGP) 500 arranged on the reflector sheet 400, a first optical film 600 arranged on the LGP 500. A frame 200 is arranged on the backplane 300 and presses against the LGP 500, a display panel 900 is supported by the frame 200, and a from frame 100 is arranged on the display panel and presses against the display panel 900 to enable the display panel 900 to be fixed above a backlight module. As shown in FIG. 2, because the display panel 900 needs to be pressed against by the front frame 100, the front frame 100 needs to be configured with a limiting structure 101 to press against the display panel 900, and the limiting structure 101 needs to be extended to a direction of the display area of the display panel 900. As shown in the FIG. 2, to ensure that the front frame 100 to press against the display panel 900, a distance that the limiting structure 101 extends to the direction of the display area of the display panel 900 is h, and the distance h that the limiting structure extends to the direction of the display area of the display panel 900 directly affects the design of narrower frame. If h is short, the effect of pressing the display panel 900 may not be achieved; if h is long, the frame of the LCD device may be wider, affecting the display range. Thus, the structure of the LCD module needs to be improved.

### SUMMARY

In view of the above-described problems, the aim of the present disclosure is to provide a display module and a display device with narrower frame.

The aim of the present disclosure is achieved by the following technical scheme. A display module comprises a liquid crystal display (LCD) panel, and a frame that supports the display panel. The frame is configured with a support structure directly supporting a back surface of the display panel, and the back surface is arranged opposite to a display surface of the display panel. A support structure of the frame is configured with suction cup(s) that holds the back surface of the display panel, the support structure of the frame is configured with a mounting hole, the suction cup is configured with a fixing column. One end of the fixing column is connected with the suction cup, another end of the fixing column is configured with a flange having a diameter more than a diameter of the mounting hole, the fixing column is arranged in the mounting hole, and the fixing column is limited in the mounting hole by the suction cup and the flange at the two ends of the fixing column. The fixing column is configured with a through hole axially arranged along the fixing column, the through hole is directly communicated with the suction cup, and the through hole is configured with a removable sealing element that seals the through hole. The frame is configured with a protecting wall that protects edges of the display panel.

The aim of the invention is further achieved by the following technical scheme. A display module comprises a display panel, and a frame that supports the display panel. The frame is configured with a support structure directly supporting the back surface of the display panel, and the back surface is arranged opposite to the display surface of the display panel. The support structure of the frame is configured with suction cup(s) holding the back surface of the display panel.

In one example, the suction cup is configured with a through hole that communicates with an atmosphere, and the through hole is configured with a removable sealing element that seals the through hole. When the LCD panel needs to be removed, only the sealing element needs to be removed to enable the suction cup to communicate with the atmosphere, thereby being convenient and fast.

In one example, the support structure of the frame is configured with a mourning hole, the suction cup is configured with a fixing column, and one end of the fixing column is connected with the suction cup, another end of the fixing column is configured with a flange having a diameter more than a diameter of the mounting hole, the fixing column is arranged in the mounting hole, and the fixing column is limited in the mounting hole by the suction cup and the flange at the two ends of the fixing column. Such structure enables the suction cup to be conveniently arranged.

In one example, the fixing column is configured with a through hole axially arranged along the fixing column, the through hole is directly communicated with the suction cup, and the through hole is configured with a removable sealing element that seals the through hole. The through hole and the sealing element are arranged on the fixing column, and the structure space of the suction cup is reasonably used.

In one example, the frame is configured with a protecting wall that protects edges of the display panel. The protecting wall can protect edges of the display panel from being damaged easily.

In one example, the frame is not configured with a protecting wall that protects edges of the display panel. Such design enables a display device without frame to be achieved, and enables the display area to be maximized while achieving a more beautiful appearance.

In one example, the suction cup is made of a rubber material. The rubber material has the advantages of high flexibility, low cost, and easy molding.

In one example, the display panel is an LCD panel or an organic light emitting display (OLED) panel.

In one example, the LCD module has no front frame. Because the suction cup is used to fix the LCD panel, the front frame is not required to be used, and the narrower frame of the LCD module is improved.

A display device comprises the display module mentioned above.

In the present disclosure, because the suction cup is arranged on the support structure of the frame that supports the display panel, the back surface of the display panel is directly held by the suction cup to enable the display panel to be fixed to the frame when installing the display panel, and the display surface of the display panel is not required to be pressed against by the front frame, thereby increasing the display area of the display device, so that the display device can have narrower frame and even have no frame.

### BRIEF DESCRIPTION OF FIGURES

FIG. 1 is a simplified structure diagram of a typical display module;

FIG. 2 is a sectional view of a typical display module;

FIG. 3 is a sectional view of a liquid crystal display (LCD) module of a first example of the present disclosure;

FIG. 4 is an enlarged view of A shown in FIG. 3;

FIG. 5 is a sectional view of a suction cup of a first example of the present disclosure;

FIG. 6 is a sectional view of an LCD module of a second example of the present disclosure;

FIG. 7 is an enlarged view of B shown in FIG. 6; and

FIG. 8 is a simplified structure diagram of an LCD module without protecting wall of a first example of the present disclosure.

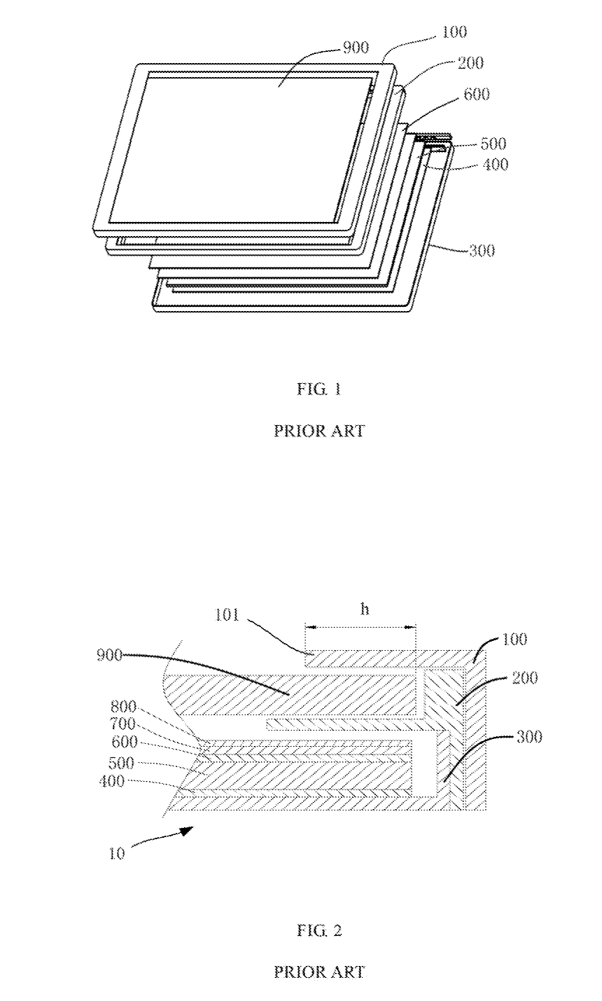

Legends: 10. backlight module; 100. front frame; 101. limiting structure; 200. frame; 210. support structure; 211. mounting hole; 220. protecting wall; 300. backplane; 400. reflector sheet; 500. light guide panel (LGP); 600. first optical film; 700. second optical film; 800. third optical film; 900. display panel; 1000. suction cup; 1010. fixing column; 1011. flange; 1100. through hole; 1110. sealing element.

### DETAILED DESCRIPTION

The present disclosure will further be described in detail in accordance with the figures and the exemplary examples.

### Example 1

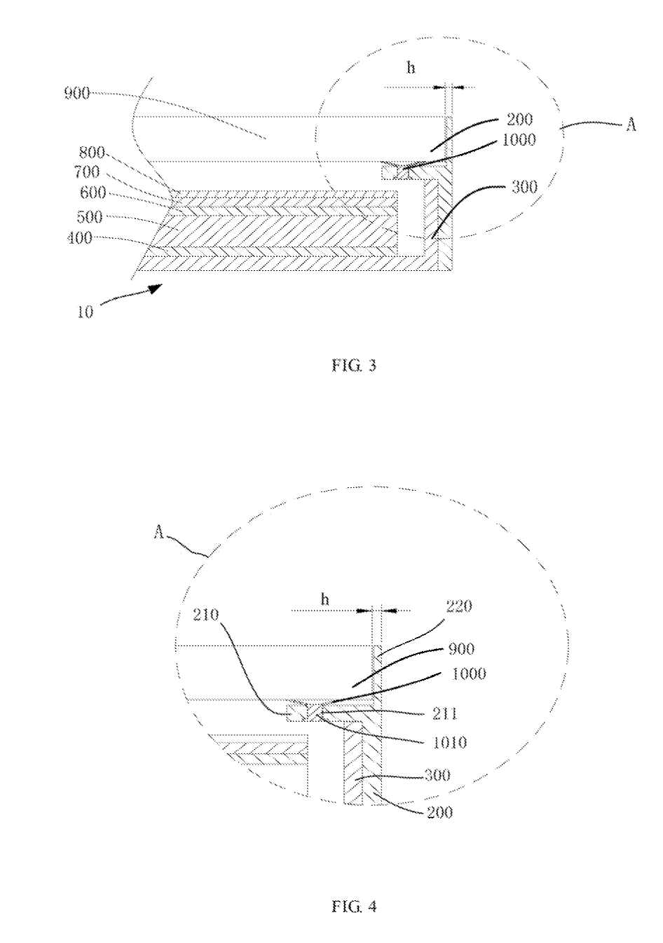

FIG. 3 shows a specific example of the present disclosure. The liquid crystal display (LCD) module comprises a backlight module 10 and a display panel 900 arranged above the backlight module 10. The backlight module 10 comprises a backplane 300, a reflector sheet 400 arranged in the backplane 300, alight guide panel (LGP) 500 arranged on the reflector sheet 400, and a first optical film 600, a second optical film 700, and a third optical film 800 which are arranged on the LGP 500. The backlight module 10 is configured with a frame 200. As shown in the FIG. 3, the frame 200 is configured with a support structure 210 used to support the display panel 900, where the support structure 210 is configured with one or more suction cups 1000, and where a back surface of the display panel 900 opposite to the LGP 500 is held by the suction cups 1000 so that the display panel 900 is fixed to the backlight module 10. When installing the display panel 900, because a lower surface of the display panel 900 is directly held by the suction cup 1000 to enable the display panel 900 to be fixed to the backlight module 10, and an upper surface of the display panel 900 is not required to be pressed against by a front frame, the front frame can be removed front the LCD module 10, thereby increasing a display area of the LCD device, to enable the frame of the LCD device to become narrower. In addition, as shown in FIG. 4, because a limiting structure that presses against the display panel 900 is not required to be used, only one protecting wall 220 with a thin thickness h is required to be provided on an edge of the display panel 900. The protecting wall 220 can protect the edge of the display panel 900 from being damaged easily. Optionally, as shown in FIG. 8, the frame 200 may be not configured with the protecting wall 220. Such design enables a display device without frame to be really achieved, and enables the display area to be maximized.

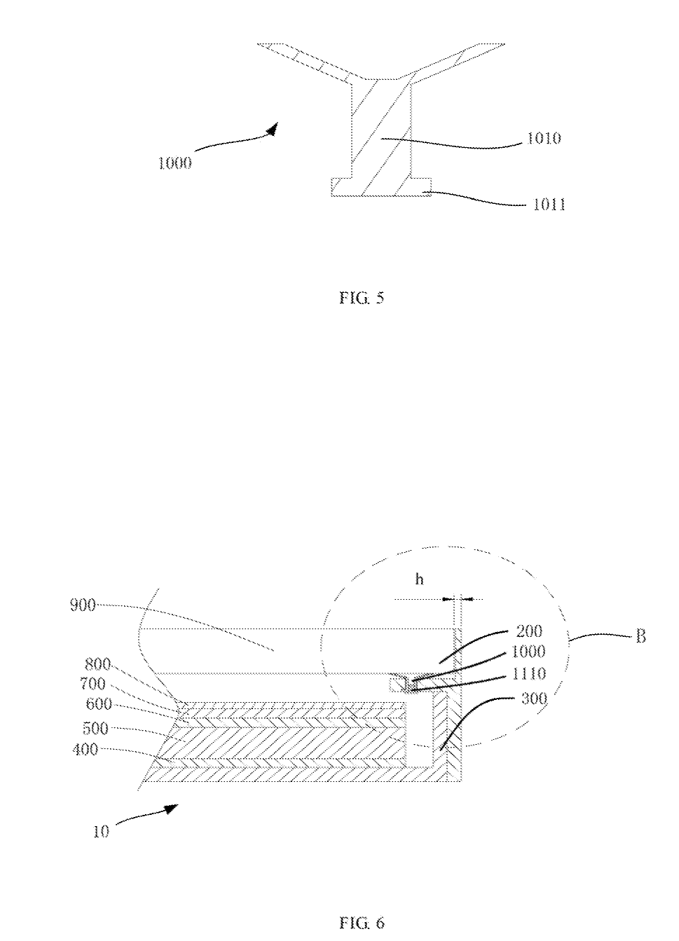

As shown in FIG. 4, the support structure 210 of the frame 200 is configured with a mounting hole 211, the suction cup 1000 is configured with a fixing column 1010, and the suction cup 1000 is fixed to the support structure 210 of the frame 200 by the fixing column 1010. As shown in FIG. 5, the suction cup 1000 in the example is made of a flexible rubber material, and one end of the fixing column 1010 is configured with the suction cup, another end of the fixing column 1010 is configured with a flange 1011 having a diameter more than that of the mounting bole 211. The suction cup 1000 is directly squeezed into the mounting hole 211 when being installed because of flexible nature of the suction cup 1000, and the fixing column 1010 is limited in the mounting hole 211 by the suction cup 1000 and the flange 1011 at the two ends of the fixing column 1010. Thus, the suction cup 1000 is fixed. The suction cup 1000 made of a highly flexible rubber has the advantages of having a simple structure and convenient to install.

### Example 2

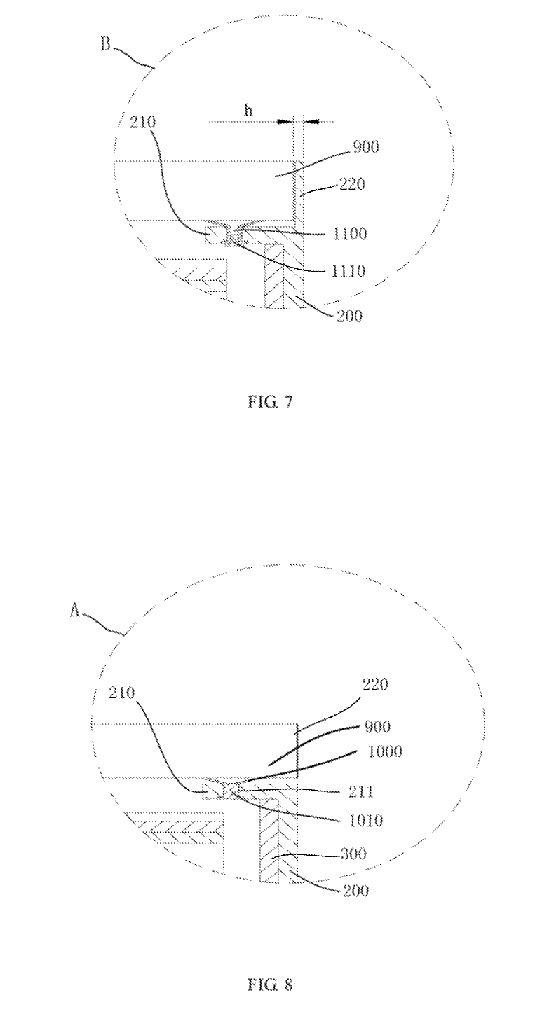

As shown in FIG. 6 and FIG. 7, the second example is different from the first example in that: in the second example, the suction cup 1000 is configured with a through hole 1100 communicated with the atmosphere, the through hole is axially arranged along the fixing column, and the through hole 1100 is configured with a removable sealing element 1110 sealing the through hole 1100. When the display panel 900 needs to be removed, only the sealing element 1110 needs to be removed to enable the suction cup 1000 to communicate with the atmosphere, thereby being convenient and fast.

As shown in FIG. 7, the through hole 1100 and the sealing element 1110 are arranged on the fixing column 1010, and the structure space of the suction cup 1000 is reasonably used.

The first example and the second example of the present disclosure respectively use the display module of the LCD device to describe the scheme of the present disclosure. Optionally, the scheme of the present disclosure is not limited to LCD devices, but is also used in organic light emitting display (OLED) devices or other fiat display devices.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A display module, comprising:
a liquid crystal display (LCD) panel; and
a frame that supports the liquid crystal display panel,
wherein the frame is configured with a support structure that directly supports a back surface of the liquid crystal display panel, and the back surface is arranged opposite to a display surface of the liquid crystal display panel;
wherein the support structure of the frame is configured with suction cup(s) that holds the back surface of the liquid crystal display panel, the support structure of the frame is configured with a mounting hole, the suction cup is configured with a fixing column; one end of the fixing column is connected with the suction cup, another end of the fixing column is configured with a flange having a diameter more than a diameter of the mounting hole; the fixing column is arranged in the mounting hole, and the fixing column is limited in the mounting hole by the suction cup and flange at the two ends of the fixing column;
wherein the fixing column is configured with a through hole axially arranged along the fixing column, the through hole is directly communicated with the suction cup, and the through hole is configured with a removable sealing element that seals the through hole; and
wherein the frame is configured with a protecting wall that protects edges of the liquid crystal display panel.

2. A display module, comprising:
a display panel; and
a frame that supports the display panel;
wherein the frame is configured with a support structure that directly supports a back surface of the display panel, and the back surface is arranged opposite to a display surface of the display panel; and
wherein the support structure of the frame is configured with suction cup(s) that holds the back surface of the display panel.

3. The display module of claim 2, wherein the suction cup is configured with a through hole that communicates with an atmosphere, and the through hole is configured with a removable sealing element that seals the through hole.

4. The display module of claim 2, wherein the support structure of the frame is configured with a mounting hole, the suction cup is configured with a fixing column, and one end of the fixing column is connected with the suction cup, another end of the fixing column is configured with a flange having a diameter more than a diameter of the mounting hole, the fixing column is arranged in the mounting hole, and the fixing column is limited in the mounting hole by the suction cup and the flange at the two ends of the fixing column.

5. The display module of claim 4, wherein the fixing column is configured with a through hole axially arranged along the fixing column, the through hole is directly communicated with the suction cup, and the through hole is configured with a removable sealing element that seals the through hole.

6. The display module of claim 2, wherein the frame is configured with as protecting wall that protects edges of the display panel.

7. The display module of claim 2, wherein the frame is not configured with a protecting wall that protects edges of the display panel.

8. The display module of claim 2, wherein the suction cup is made of a rubber material.

9. The display module of claim 2, wherein the display panel is a liquid crystal display (LCD) panel or an organic light emitting display (OLED) panel.

10. The display module of claim 9, wherein the display module has no front frame.

11. A display device, comprising:
a display panel; and
a frame that supports the display panel;
wherein the frame is configured with a support structure directly supporting a back surface of the display panel, and the back surface is arranged opposite to a display surface of the display panel; and
wherein the support structure of the frame is configured with suction cup(s) that holds the back surface of the display panel.

12. The display device of claim 11, wherein the suction cup is configured with a through hole that communicates with an atmosphere, and the through hole is configured with a removable sealing element that seals the through hole.

13. The display device of claim 11, wherein the support structure of the frame is configured with a mounting hole, the suction cup is configured with a fixing column and one end of the fixing column is connected with the suction cup, another end of the fixing column is configured with a flange having a diameter more than a diameter of the mounting hole, the fixing column is arranged in the mounting hole, and the fixing column is limited in the mounting hole by the suction cup and the flange at the two ends of the fixing column.

14. The display device of claim 13, wherein the fixing column is configured with a through hole axially arranged along the fixing column, the through hole is directly communicated with the suction cup, and the through hole is configured with a removable sealing element that seals the through hole.

15. The display device of claim 11, wherein the frame is configured with a protecting wall that protects edges of the display panel.

16. The display device of claim 11, wherein the frame is not configured with a protecting wall that protects edges of the display panel.

17. The display device of claim 11, wherein the suction cup is made of as rubber material.

18. The display device of claim 11, wherein the display panel is a liquid crystal display (LCD) panel or an organic light emitting display (OLED) panel.

19. The display device of claim 18, wherein the display module has no front frame.
